(19) United States
(12) Patent Application Publication
(10) Pub. No.: US 2006/0019108 A1
(43) Pub. Date: Jan. 26, 2006

(54) Method for producing an inorganic cover layer on the surface of a product and panel-shaped or strip-shaped product

(76) Inventor: Stefan Hoveling, Osnabruck (DE)

Correspondence Address: Richard L. Mayer, Esq.;KENYON & KENYON, One Broadway, New York, NY, 10004, US

(21) Appl. No.: 11/189,602

(22) Filed: Jul. 25, 2005

(30) Foreign Application Priority Data
Jul. 24, 2004 (DE) 10 2004 036 082.0

(51) Int. Cl. B32B 15/04

(52) U.S. Cl. 428/469

(57) ABSTRACT

A method for generating an inorganic, colored cover layer on the surface of a product (strip, sheet metal, panel) having a base material made of copper or a copper alloy, using a reactive chemical that forms metal salts. While degreasing the surface of the base material of the product, a preoxidation layer is generated that is made of oxides of the base material. The preoxidation layer is then wet film-like by the reactive chemical that forms metal salts. For this, patterned application rolls may be used.

### FIELD OF THE INVENTION

The invention relates to a method for producing an inorganic, colored cover layer on the surface of product having a base material made of copper or a copper alloy using a reactive chemical that forms metal salts. The invention further relates to a panel-shaped or strip-shaped product having a base material made of copper or a copper alloy.

### DESCRIPTION OF RELATED ART

It is a part of the related art to cover roofs, walls or fascias using panels or sheet metal having a base material made of copper or a copper alloy. In doing so, one is making an attempt largely to adapt the surfaces of the panels or the sheet metal that is facing the surroundings, both in color and in structure, to the object on which the panels or sheet metals are to show to advantage, in an optically appealing manner.

However, most of the products that are on the market for these application cases fulfill these demands only partially, since, on the one hand, they have colors and, on the other hand, they have patterns (structures) which can hardly be varied in their optics or not at all, for reasons of technical methodology. Among these items are particularly surfaces having green patinas or brown oxidation of panels or sheet metal having copper or copper alloys as their base material.

In the methods known in this connection, for producing green cover layers on products made of copper or copper alloys—artificially produced patina layers—layers of metal salts are produced, by chemical or electrochemical methods, as well as by combinations of these two methods, on the surfaces of the panels and metal sheets used for application areas concerning roofs, walls and fascias. The patina surfaces created thereby are more or less uniform as far as color is concerned.

Basically, these artificially generated patina surfaces may be subdivided into two groups. Within the scope of the one group, layers of metal salts are applied to the surface, using various application methods. The composition of these patina layers does not change any more, because they do not react with the base material on which they are applied. However, those layers may be optically changed by the variation of the composition and the manner of the application method, but they adhere only poorly to the base material. The reason is that there is no chemical reaction, and thus there is no chemical connection to the base material.

The second group has in it patina layers that are created from the base material by the application of a chemical to the surface, or using the reaction of the surface of the base material with an appropriate liquid. In this case, the artificially generated patina layer is the reaction product between the base material and an appropriate chemical. The advantage of patina layers artificially generated in this fashion is their good connection to the base material, giving it very good adherence. However, it is disadvantageous that the color and structure of the patina layers are established by the optical properties of the respective reaction product. The appearance of such a patina layer is only able to be varied if the composition of the chemical taking part in the reaction is changed.

With regard to the brown cover layers on the surfaces of products made of copper or copper alloys for roofs, walls and fascias (commercially artificially generated metal oxides), the products have on their surfaces thin layers made of metal oxides. These are generated using thermal, chemical or electrochemical methods, as well as combinations of these methods. Even these thin layers have a more or less uniform appearance as far as color is concerned.

Apart from the methods described above, there are still other various types of organic protective and decorative layers which are applied to metal surfaces using various methods. However, these layers, based on their organic structure, do not have a service life or resistance to weathering comparable to metal oxides.

### SUMMARY OF THE INVENTION

It is an object of the invention to produce a protective layer and cover layer on products made of copper or a copper alloy that is optically appealing and is easy to modify in its color shade and resistant to weathering. It is a related object of the invention to create a panel-shaped or strip-shaped product having a base material made of copper or a copper alloy, having such a protective and cover layer.

In accordance with the present invention, these and other objects are achieved by a method for generating an inorganic, colored cover layer on the surface of a product having a base material made of copper or a copper alloy, using a reactive chemical that forms metal salts, wherein while degreasing the surface of the base material of the product, a preoxidation layer made of oxides of the base material is first formed on the surface; and the preoxidation layer is then wet film-like by the reactive chemical that forms metal salts.

The invention further provides a panel-shaped or strip-shaped product having a base material made of copper or a copper alloy, onto the surface of at least one flat side of the product a preoxidation layer made of oxides of the base material being applied, and the preoxidation layer being wet by a cover layer made of a reactive chemical that forms metal salts.

### DETAILED DESCRIPTION OF THE INVENTION

The crux of the present invention is the combination of various method parameters. First, a layer is generated on the surface of a product having a base material made of copper or a copper alloy which is made up of oxides of the base material. In this process, the surface of the product changes not only as to color, but is also simultaneously degreased substantially. The base color of the preoxidation layer may be set over a wide range, depending on the choice of the combination of the alloy and the oxidation parameters.

The largely degreased surface of the product forms a predisposition so that, according to the present invention, in an additional operation, a reactive chemical may be applied that leads to the formation of metal salts. The film-like wetting with the chemical is markedly improved by the preoxidation layer previously generated on the surface of the product.

The reactive chemical may be applied in such a way that an optically appealing pattern is created which, depending on the reaction between the chemical and the wetted surface of the product, lets a marbled appearance be created that is between beige-brown to brown and gold-brown and green. By combination of the method parameters, decorative and optically appealing layers may be generated, on the one hand, made of metal salts, and, on the other hand, made of metal oxides on the products made of copper or copper alloys, whose appearance may be widely varied as to color and structure, depending on requirements. These metal salt/metal oxide layers have an excellent resistance to weathering, since they are, on the one hand, generated from the base material itself of the products, and on the other hand, they largely correspond, in their structure and their composition, to the naturally created corrosion products.

In a refinement according to the invention, the preoxidation layer is generated thermally, chemically or electrochemically.

It is particularly advantageous that the chemical is applied using at least one application roll. By an appropriate design (structuring) of the application roll, the pattern may be generated purposefully on t b he surface of the product that is adapted to the object into which the product is to be installed.

The method according to the invention may be used for a panel-shaped or strip-shaped product having a base material made of copper or a copper alloy.

A particularly advantageous development with respect to the adherence of the metal salt layer on the preoxidation layer is provided, if the method is used on a panel-shaped or strip-shaped product having a base material made of copper or a copper alloy that has zinc at least in the region that is near to the surface.

What is claimed is:

1. A method for generating an inorganic, colored cover layer on the surface of a product having a base material made of copper or a copper alloy, using a reactive chemical that forms metal salts, comprising: while degreasing the surface of the base material of the product, first forming a preoxidation layer made of oxides of the base material on the surface; and then wetting film-like the preoxidation layer with the reactive chemical that forms metal salts.

2. The method according to claim 1, wherein the preoxidation layer is generated thermally, chemically or electrochemically.

3. The method according to claim 1, wherein the reactive chemical is applied using at least one application roll.

4. The method according to claim 2, wherein the reactive chemical is applied using at least one application roll.

5. The method according to claim 1, wherein the product is a panel-shaped or strip-shaped product having a base material made of copper or a copper alloy.

6. The method according to claim 2, wherein the product is a panel-shaped or strip-shaped product having a base material made of copper or a copper alloy.

7. The method according to claim 3, wherein the product is a panel-shaped or strip-shaped product having a base material made of copper or a copper alloy.

8. The method according to claim 4, wherein the product is a panel-shaped or strip-shaped product having a base material made of copper or a copper alloy.

9. The method according to claim 5, wherein the product has zinc at least in a region close to the surface.

10. The method according to claim 6, wherein the product has zinc at least in a region close to the surface.

11. The method according to claim 7, wherein the product has zinc at least in a region close to the surface.

12. The method according to claim 8, wherein the product has zinc at least in a region close to the surface.

13. A panel-shaped or strip-shaped product having a base material made of copper or a copper alloy, having a preoxidation layer made of oxides of the base material applied on a surface of at least one flat side of the product, wherein the preoxidation layer is wet by a cover layer made of a reactive chemical that forms metal salts.
